(19) United States
(12) Patent Application Publication
(10) Pub. No.: US 2004/0202302 A1
(43) Pub. Date: Oct. 14, 2004

(54) Telephone number with extension distribution system and method

(76) Inventor: Scott Richards, Los Angeles, CA (US)

Correspondence Address: SNELL & WILMER LLP, 1920 MAIN STREET, SUITE 1200, IRVINE, CA, 92614-7230, US

(21) Appl. No.: 09/741,277

(22) Filed: Dec. 19, 2000

(51) Int. Cl. H04M 3/42; H04M 7/00; H04L 12/66

(52) U.S. Cl. 379/201.12; 379/222; 370/352

(57) ABSTRACT

The present invention is a telephone number with extension distribution system and method, preferably for toll-free vanity telephone numbers. The preferred embodiment of the system for distributing telephone numbers comprises a client computer connected to a server through the Internet. The server interfaces with a database, preferably using a TCP/IP network. The database contains (i) telephone numbers, preferably toll-free, (ii) extensions affiliated with the telephone numbers (iii) terminating telephone number(s) assigned to a telephone number and affiliated extension. The client computer can search the database and select a telephone number and select an available extension. The client computer then inputs a terminating telephone number(s) to be associated with the telephone number and affiliated extension. The database server containing telephone numbers and affiliated extensions interfaces with the server and the Interactive Voice Response (“IVR”) system. The IVR interfaces with the PBX switch which is the gateway to the Public Switched Telephone Network (“PSTN”). The preferred embodiment of the invention further comprises an electronic mail server containing electronic mail addresses, whereby the user name (before the @ sign) is preferably the telephone number extension and the domain name preferably matches the telephone number (after the @ sign).

### TECHNICAL FIELD

The present invention is a telephone number with extension distribution system and method, preferably for toll-free vanity telephone numbers.

### BACKGROUND ART

The use of a company's telephone number is often a primary avenue for new customers to make initial contact with the company. Businesses often have toll-free telephone numbers so that the business can bear the cost of calls from potential customers. Thus, the consumer's cost to contact a business and, therefore, the initial consumer reluctance to call is reduced by having a toll-free telephone number.

Additionally, businesses obtain data, including potential customer calling lists, by virtue of owning toll-free telephone numbers. Unlike regular telephone numbers, a toll-free number is a digital signal that carries with it valuable information that is used to receive and route calls through the Dialed Number Identification System (DNIS).

Toll-free telephone numbers currently have area code prefixes of 800, 888, 877, and 866. More than 1,000 companies currently offer toll-free numbers for both business and individual use. These toll-free service providers are known as “Responsible Organizations” or “Resp Orgs.” A Resp Org is a service bureau, Long Distance Company or other business responsible for the day to day duties of maintaining a toll-free number, including preparing billing invoices and making customer-initiated changes when necessary. Resp Orgs including companies, inter alia, such as AT&T, MCI/WorldCom and Sprint as well as smaller companies. Generally, Resp Orgs have access to the SMS/800-number database, which is the national, computerized database system that supports centralized, toll-free service administration, and can reserve numbers for individual subscribers.

A toll-free telephone number that is easy for potential customers to remember is desirable to businesses. A common way of obtaining a memorable telephone number is to select a number that resolves to a word, words, message or familiar alphanumeric combination on a common telephone number pad. For example, the toll-free phone number 1-800-838-3726 resolves to 1-800-VETERAN on a standard telephone number pad. This is usually easier to remember for a potential customer than a string of 11 seemingly random numbers.

On a standard English telephone number pad, 2 represents the letters A, B and C; 3 is D, E and F; 4 is G, H, and I; 5 is J, K and L; 6 is M, N, and O; 7 is P, R and S; 8 is T, U, and V; and 9 is W, X and Y. The numbers 1 and “0” (Zero) do not represent letters of the alphabet on a standard keypad.

Currently, there are a finite number of toll-free telephone numbers available to the public as distributed by the various telephone companies. Of this finite number, a smaller set of toll-free telephone numbers resolve into a word, words, message or easy to remember alphanumeric combination when translated using a standard telephone number keypad (hereinafter “vanity numbers”.) Due to the short supply of vanity numbers there are businesses engaged in licensing vanity numbers to third parties.

The most common method of licensing vanity numbers is to divide the vanity number's use among area codes. For example, Licensee A in Los Angeles can license a vanity number for the area code 310 while Licensee B in New York can license the same vanity number for the area code 212. However, the number of area codes in the United States and or any other country is finite. Using area code divisions, the availability of a vanity number is limited to the number of area codes by which a vanity number can be divided.

Thus, there is a need for a method and system of distributing telephone numbers, preferably toll-free vanity numbers, to individual and businesses without being limited by area codes.

### SUMMARY OF THE INVENTION

The present invention is a telephone number with extension distribution system and method, preferably for toll-free vanity telephone numbers. The preferred embodiment of the system for distributing telephone numbers comprises a client computer connected to a server through the Internet. The server interfaces with a database, preferably using a TCP/IP network. The database contains (i) telephone numbers, preferably toll-free, (ii) extensions affiliated with the telephone numbers and (iii) terminating telephone number(s) assigned to a telephone number and affiliated extension. The client computer can search the database and select a telephone number and select an available extension. The client computer then inputs a terminating telephone number(s) to be associated with the telephone number and affiliated extension. The database server containing telephone numbers and affiliated extensions interfaces with the server and the Interactive Voice Response (“IVR”) system. The IVR interfaces with the Private Branch Exchange (“PBX”) switch which is the gateway to the Public Switched Telephone Network (“PSTN”). The preferred embodiment of the invention further comprises an electronic mail server containing electronic mail addresses, whereby the user name (before the @ sign) is preferably the telephone number extension and the domain name preferably matches the telephone number (after the @ sign).

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a diagram of a preferred embodiment of the system.

FIG. 2 is a flow chart of a preferred method for a caller to access the system.

### DETAILED DESCRIPTION OF TEE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a telephone number with extension distribution system and method.

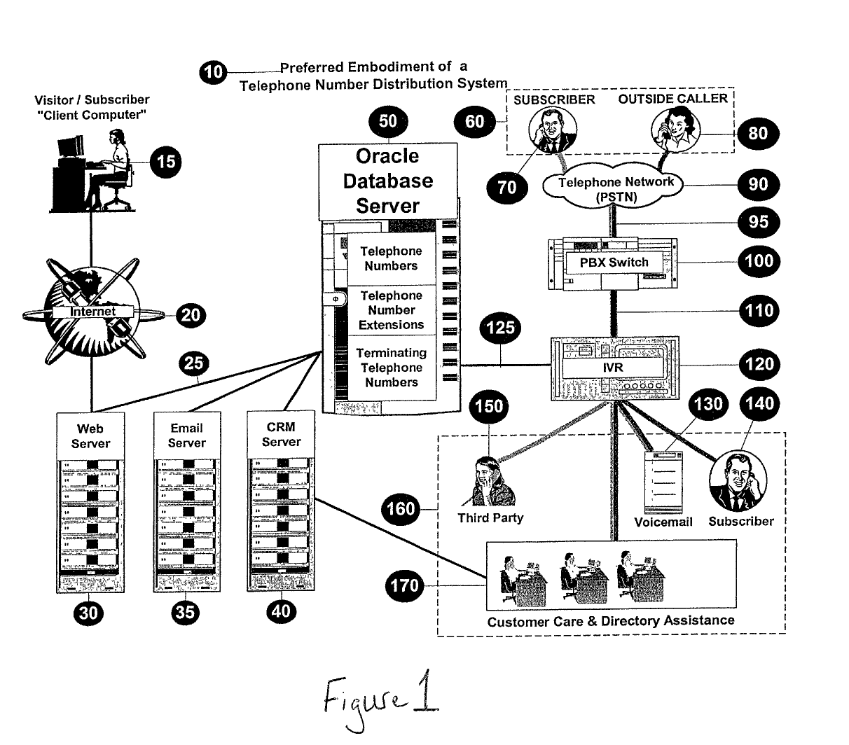

Referring now to FIG. 1, a diagram of a preferred embodiment of a telephone number distribution system 10 is shown. A client computer 15, preferably of a potential subscriber, is connected to a server 30, preferably a web server, over a network 20, preferably the Internet 20. The server 30 is interfaced preferably via a TCP/IP connection 25 with a database server 50 preferably housing an Oracle® database, containing telephone numbers, preferably toll-free vanity numbers, telephone number extensions assigned to the telephone numbers, and terminating telephone numbers assigned to telephone numbers and affiliated telephone number extensions. The telephone number extensions can be entered as numbers or letters on a standard telephone keypad. The telephone number extensions are preferably two to six digits long.

The client computer 15 can search the telephone number database 50 and select a telephone number. Preferably, the client computer 15 inputs a desired telephone number and/or search criterion into a telephone number search engine such as, inter alia, the business or personal interests of the potential subscriber. For example, search criterion for a potential subscriber could be a variety of items or strings of items including but not limited to “locksmith,” “lawyer”, “solution”, “The Pittsburgh Steelers,” or “single mom.” The search engine will search the database 50 for a telephone number that matches the desired telephone number search query. If no matching telephone number exists in the database 50, the search engine will suggest related telephone numbers present in the database 50 according to the search criteria and their relationship to telephone numbers present in the database 50.

The client computer 15 then inputs a desired telephone number extension into an extension finder search engine. For example, the client computer 15 can select the vanity number 1-800-VETERAN and then select the telephone number extension “100” creating 1-800-VETERAN ext. 100. A telephone number extension that resolves to a word is also possible. For example, the extension could be a name like JOHN thereby creating 1-800-VETERAN ext. JOHN.

The client computer 15 then inputs a terminating telephone number(s) and assigns the terminating telephone number(s) to the telephone number and affiliated telephone number extension. The PBX switch 100 connects an Interactive Voice Response (“IVR”) system 120 to the telephone network 90, such as the telephone network of AT&T. The PBX switch 100 is preferably a Nortel Meridian Option 61. Preferably, the Database Server 50 is connected to or integrated with the IVR 120 running Envox CT-Studio software, preferably that interfaces with the PBX Switch 100 via a line-side T1 connection 110. The IVR 120 allows voice commands and telephone button entries to be transmitted to the database 50 and the PBX Switch 100. Preferably, the IVR 120 is co-located with the PBX Switch 100, preferably by the line-side T1 connection 110, that will handle all call routing for each subscriber account. The database 50 will access call detail from the IVR 120 and PBX switch 100 for accounting and reporting purposes for each subscriber account via a network connection 125.

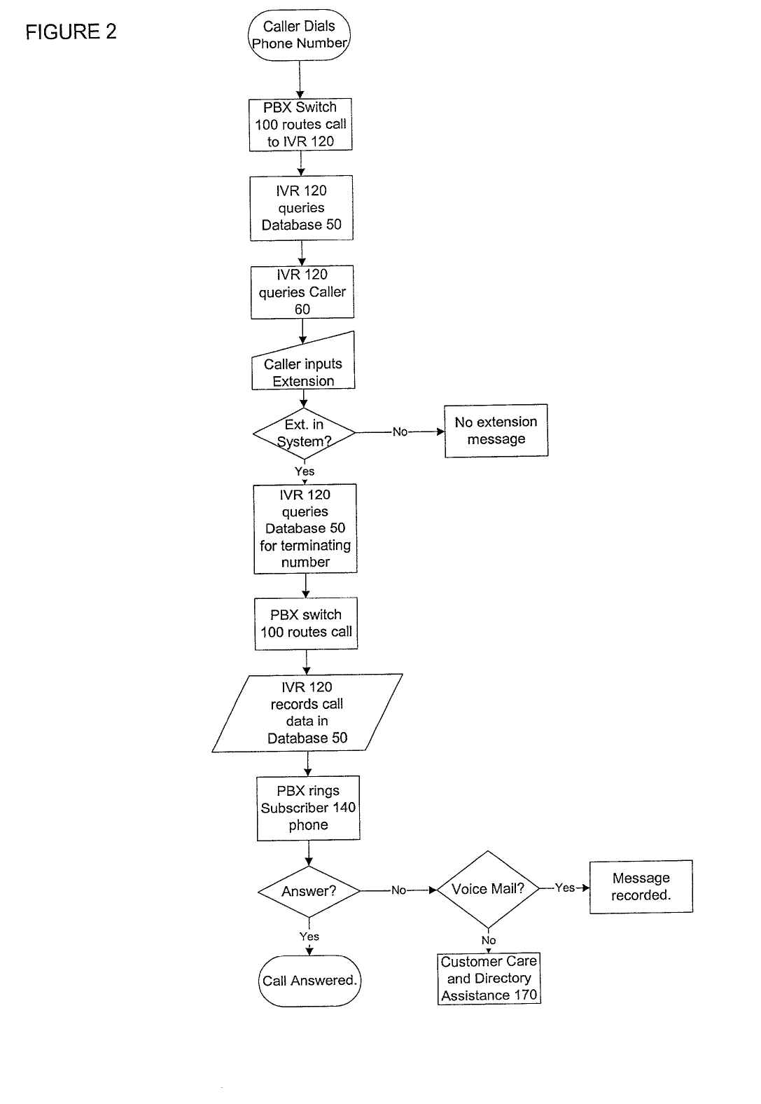

FIG. 2 is a flowchart showing how an outside caller 80 or a subscriber 70 accesses a telephone number using the system 10, in particular using the phone number 1-800-VETERAN as an example. Referring now to FIG. 2, to access the system 10, a caller 60 dials a telephone number recorded in the database 50. The call, via the telephone network 90 and is routed to the system 10 over a high-speed connection, preferably a T-1 line 95 which is connected to the PBX switch 100. The PBX switch 100 routes the call over another high speed connection, preferably a line-side T-1 110 to the IVR 120, which will query the database 50 based on the DNIS received, to determine which extensions and/or options are available to the caller 60. The IVR 120 will then ask, via a computerized voice prompt, the caller 60 to input the extension of the subscriber 140 that the caller 60 is seeking to connect. The caller 60 then inputs the desired telephone number extension via the caller's telephone keypad. The IVR 120 will then query the database 50 to extract the terminating telephone number(s) of the subscriber 140 and will then route the call, via the PBX Switch 100, to the correct subscriber's 140 terminating telephone number and record the telephone number and other call detail information of the caller in the database 50. If the routed call to the terminating telephone number, is not answered, the IVR 120 can direct the caller 60 to a voice mail system 130, so that the caller 60 can leave a message or be directed to customer care & directory assistance 170. The caller could also be routed to a third party 150. The voice mail system 130 is preferably a computer using Envox CT-Studio voice mail system software and a disk array for storage.

The preferred embodiment of the system 10 further comprises an electronic mail server 35 containing electronic mail addresses assigned to subscribers, whereby the user name (before the @ sign) is preferably the telephone number extension and the domain name (after the @ sign) preferably matches the telephone number. For example, a user with the vanity number 1-800-VETERAN ext. JOHN could have a corresponding electronic mail address of john@1800VETERAN.com.

The preferred embodiment of the system 10 further comprises a customer relations management (“CRM”) server 40 connected by TCP/IP connection 25 to the database 50 and to the Customer Care and Directory Assistance 170.

In summary, the preferred embodiment of this new and novel system for distributing toll-free telephone numbers allows a user to self-select a toll-free “vanity” telephone number over the Internet 20 and share that toll-free vanity telephone number with multiple related or unrelated users by virtue of a telephone number extension selected by the user. Thus, a telephone number with extension distribution system and method is described above.

In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A method for distributing telephone numbers comprising the following:
connecting a client computer to a server at a location remote from the client computer;
searching a telephone number database;
selecting a telephone number from the telephone number database;
selecting a telephone number extension for the telephone number;
inputting a terminating telephone number to the telephone number database; and,
assigning the terminating telephone number to the telephone number and telephone number extension in the telephone number database.

2. The method of claim 1 where the telephone number is a toll-free telephone number.

3. The method of claim 1 where the telephone number is alphanumeric.

4. The method of claim 1 further comprising:
connecting the telephone number database to a telephone network; and,
bridging phone calls to the telephone number and telephone number extension to the terminating telephone number.

5. The method of claim 1 further comprising assigning an electronic mail address to the telephone number.

6. The method of claim 5 where the electronic mail address comprises a domain name having the telephone number.

7. The method of claim 1 further comprising assigning a voice mail box to the telephone number and telephone number extension.

8. The method of claim 1 where searching the telephone number database is done using a search engine.

9. A method for distributing telephone numbers comprising the following:
connecting a client computer to a server at a location remote from the client computer;
searching a telephone number database of toll-free telephone numbers;
selecting a toll-free telephone number from the telephone number database;
selecting a telephone number extension for the toll-free telephone number;
inputting a terminating telephone number to the telephone number database;
assigning the terminating telephone number to the toll-free telephone number and telephone number extension in the telephone number database;
connecting the telephone number database to a telephone network; and,
bridging phone calls to the telephone number and telephone number extension to the terminating telephone number.

10. The method of claim 9 where the toll-free telephone number is alphanumeric.

11. The method of claim 9 further comprising assigning an electronic mail address to the telephone number.

12. The method of claim 11 where the electronic mail address comprises a domain name having the telephone number.

13. The method of claim 9 further comprising assigning a voice mail box to the toll-free telephone number and telephone number extension.

14. A system for distributing telephone numbers comprising a client computer connected to a server through a network; the server having a telephone number database containing terminating telephone numbers assigned to telephone numbers and affiliated telephone number extensions whereby the client computer can search the telephone number database and select a telephone number and affiliated telephone number extension, input a terminating telephone number, and assign the terminating telephone number to the telephone number and the affiliated telephone number extension.

15. The system of claim 14 where the telephone number is a toll-free telephone number.

16. The system of claim 15 where the toll-free telephone number is alphanumeric.

17. The system of claim 14 where the server and telephone number database is connected to a telephone network by a PBX switch.

18. The system of claim 14 where the server further comprises an electronic mail server containing electronic mail addresses assigned to the telephone numbers and affiliated telephone number extensions; the electronic mail server accessibly connected to the client computer by the network.

19. The system of claim 14 where the network is the Internet.

20. The system of claim 14 where the server further has a separate voice mail box assigned to each telephone number and affiliated telephone number extension; each separate voice mail box being accessible from a telephone network.

21. A system for distributing toll-free telephone numbers comprising a client computer connected to a server through the Internet; the server having a telephone number database containing terminating telephone numbers assigned to toll-free telephone numbers and affiliated telephone number extensions whereby the client computer can search the telephone number database and select a toll-free telephone number and affiliated telephone number extension, input a terminating telephone number, and assign the terminating telephone number to the toll-free telephone number and the affiliated telephone number extension; the server and telephone number database being connected to a telephone network by a PBX switch; the telephone number and the affiliated telephone number extension being accessible by the PBX and an IVR.
